(19) United States
(12) Patent Application Publication
(10) Pub. No.: US 2007/0296817 A1
(43) Pub. Date: Dec. 27, 2007

(54) Smart Video Surveillance System Ensuring Privacy

(76) Inventors: Touradj Ebrahimi, Pully (CH); Frederic A. Dufaux, Bois D' Amont (FR)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/631,806

(22) PCT Filed: Jul. 7, 2005
(86) PCT No.: PCT/IB05/02989

§ 371 Date: Aug. 24, 2007

Related U.S. Application Data
(60) Provisional application No. 60/521,847, filed on Jul. 9, 2004.

(51) Int. Cl. H04N 7/18

(52) U.S. Cl. 348/161; 348/E07.085

(57) ABSTRACT

This invention describes a video surveillance system which is composed of three key components 1—smart camera(s), 2—server(s), 3—client(s), connected through IP-networks in wired or wireless configurations. The system has been designed so as to protect the privacy of people and goods under surveillance. Smart cameras are based on JPEG 2000 compression where an analysis module allows for efficient use of security tools for the purpose of scrambling, and event detection. The analysis is also used in order to provide a better quality in regions of the interest in the scene. Compressed video streams leaving the camera(s) are scrambled and signed for the purpose of privacy and data integrity verification using JPSEC compliant methods. The same bit stream is also protected based on JPWL compliant methods for robustness to transmission errors. The operations of the smart camera are optimized in order to provide the best compromise in terms of perceived visual quality of the decoded video, versus the amount of power consumption. The smart camera(s) can be wireless in both power and communication connections. The server(s) receive(s), store(s), manage(s) and dispatch(es) the video sequences on wired and wireless channels to a variety of clients and users with different device capabilities, channel characteristics and preferences. Use of seamless scalable coding of video sequences prevents any need for transcoding operations at any point in the system.

### CROSS REFERENCE TO RELATED APPLICATIONS

This application claims the benefit of U.S. patent application Ser. No. 60/521,847, filed on Jul. 9, 2004, hereby incorporated by reference

### BACKGROUND OF THE INVENTION

1. Field of the Invention

The present invention relates to a video surveillance system and more particularly to a video surveillance system which includes at least one smart video surveillance camera, configured to automatically identify persons and regions of interest in video scenes and which scrambles the images of persons in captured video scenes to preserve privacy rights and encodes the video data, for example, using a standard digital compression technique, such as JPEG-2000, and transmits the video data over a computer network, for example, an IP network, to enable clients connected to the network to view live or stored data.

2. Description of the Prior Art

With the increase of threats and the high level of criminality, security remains a major public concern worldwide. Video surveillance is one approach to address this issue. Besides public safety, these systems are also useful for other tasks, such as regulating the flow of vehicles in crowded cities. Large video surveillance systems have been widely deployed for many years in strategic places, such as airports, banks, subways or city centers. However, many of these systems are known to be analog and based on proprietary solutions. It is expected that the next generation of video surveillance systems will be digital and based on standard technologies and IP networking.

Another expected evolution is towards smart video surveillance systems. Current systems are limited in their capability and are limited to capture, transmit and store video sequences. Such systems are known to rely on human operators to monitor screens in order to detect unusual or suspect situations and to set off an alarm. However, their effectiveness depends on the sustained attention of a human operator, known to be unreliable in the past. In order to overcome this problem, video surveillance systems have been developed which analyze and interpret captured video. For example, systems for analyzing video scenes and identifying human faces are disclosed in various patents and patent publications, such as: U.S. Pat. Nos. 5,835,616; 5,991,429; 6,496,594; 6,751,340; and U.S. Patent Application Publication Nos. US 2002/0064314 A1; US 2002/0114464 A1; US 2004/0005086 A1; US 2004/0081338 A1; US 2004/0175021 A1; US 2005/0013482 A1. Such systems have also been published in the literature. See for example; Hampapur et al, “Smart Surveillance: Applications, Technologies and Implications,” Proceedings of the IEEE Pacific Rim Conference on Multimedia, December 2003, vol. 2, pages 1133-1138; and Cai et al, “Model Based Human Face Recognition in Intelligent Vision,”, Proceedings of SPIE, volume 2904, October 1996, pages 88-99, all hereby incorporated by reference. While such systems are thought to provide a sense of increased security, other issues arise, such as a fear of a loss of privacy.

Surveillance systems have been developed which address the issue of privacy. For example, U.S. Pat. No. 6,509,926 discloses a video surveillance system which obscures portions of captured video images for privacy purposes. Unfortunately, the obscured portions relate to fixed zones in a scene and are thus ineffective to protect the privacy of persons or objects which appear outside of the fixed zone. In addition, the obscured portions of the images can not be reconstructed in the video surveillance system disclosed in the '926 patent. Thus, there is need for a video surveillance system that not only can recognize regions of interest in a video scene, such as human faces, but at the same time preserves the privacy of the persons or other objects, such as license plate numbers, by scrambling portions of the captured video content and also allow the scrambled video content to be selectively unscrambled.

### SUMMARY OF THE INVENTION

Briefly, the present invention relates to a smart video surveillance system which integrates a video analysis of regions of interest in scene, to identify objects, such as human faces, with a scrambling technique to protect the privacy of the persons or other objects of interest in a scene. The smart video surveillance system in accordance with the present invention includes at least one smart surveillance camera, which may includes a camera and, for example, a personal computer. Each smart surveillance camera captures video content of interest; analyzes the video content to identify human faces or other objects of interest in a scene; encodes the video content using a standard video compression technique, such as JPEG-2000; and transmits the data over, for example, an IP (internet protocol) network, to a server for storage. Portions of the video content corresponding to human faces or other objects of interest are scrambled to preserve privacy rights. In accordance with an important aspect of the invention, the scrambled portions of the video content may be selectively unscrambled to allow identification of persons or objects of interest. In addition, the encoded video data may also be encrypted for security. Various clients connected to the network are configured to view either live or stored video content by accessing the server over the network.

### DESCRIPTION OF THE DRAWING

These and other advantages of the present invention will be readily understood with reference to the following description and attached drawing, wherein:

FIG. 1 is high level diagram of an exemplary architecture for a smart video surveillance system in accordance with the present invention.

FIG. 2 is a simplified flow chart for the system in accordance with the present invention.

FIG. 3 is an exemplary photograph illustrating an exemplary background scene for use with change detection processing in accordance with the present invention.

FIG. 4 illustrates four exemplary scenes to illustrate scene change detection which illustrates a bounding box around the changed regions of the scenes on the top row while the bottom row illustrates the regions within the bounding boxes scrambled.

FIG. 5 illustrates two exemplary scenes used for face detection illustrating the faces within a bounding box on the top row while the bottom row illustrates the regions within the bounding boxes scrambled

### DETAILED DESCRIPTION

The system in accordance with the present invention relates to a video surveillance system which can analyze the video content and identify human faces or other objects of interest in a video scene, such as a license plate. In accordance with an important aspect of the invention, human faces or other objects of interest in a scene are scrambled to preserve privacy.

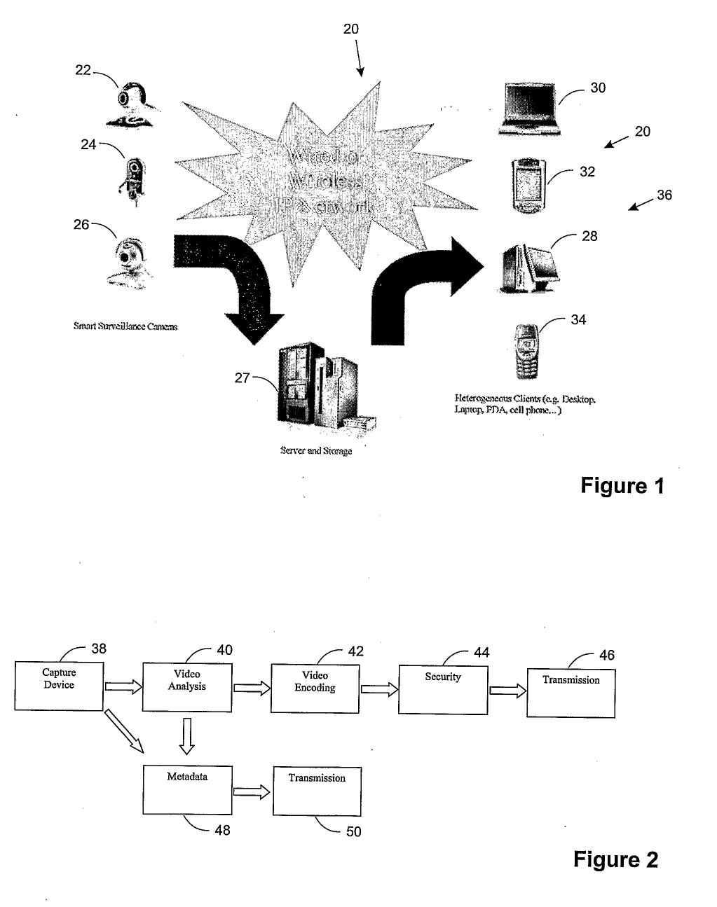

Referring to FIG. 1, a high level diagram of the video surveillance system in accordance with the present invention is illustrated and identified with the reference numeral 20. The video surveillance system 20 includes one or more smart surveillance cameras 22, 24 and 26. Each smart surveillance camera 22, 24 and 26 is positioned to cover an area of interest to be monitored. Each smart surveillance camera 22, 24 and 26 may be either powered by electrical cable, or have its own autonomous energy supply, such as a battery or a combination of batteries and solar energy sources. The smart surveillance cameras 22, 24 and 26 may be coupled to a wired or wireless network. Wireless networks, such as WiFi networks facilitate deployment and relocation of surveillance cameras to accommodate changing or evolving surveillance needs.

Each smart surveillance camera 22, 24 and 26 processes the captured video sequence in order to identify human faces or other objects of interest in a scene and encodes the video content using a standard video compression technique, such as JPEG-2000. The encoded data is then transmitted over a private or public, wired or wireless network, such as an IP network, to a server 27, for storage. The server 27, for example, a desktop PC running conventional web server software, such as the Apache HTTP server from the Apache Software Foundation or the Internet Information Services (IIS) from Microsoft, stores the data received from the various surveillance cameras, along with corresponding optional metadata information from the video analysis (e.g. events detection). Based on this metadata information, the server 27 may trigger alarms and archive the sequences corresponding to events. The server 27 can optionally store the transmitted video and associated metadata, either continuously or when special events occur.

One or more clients 36, such as desk top personal computers (PC) 28, lap top PCs 30, personal digital assistants (PDA) 32 and cellular phones 34 may be coupled to a wired or wireless private or public network, such as an IP network. These clients 36 are configured to access, live and stored video content stored, at the server 27 over the network. Since the stored video content is scalable, the server 27 is able to adapt the resolution and bandwidth of the delivered video depending on the performance and characteristics of the client 36 and its network connection, or user preferences over a wired or wireless network. In accordance with an important aspect of the invention, the system can be configured to permit access by mobile clients, such as laptop PCs and/or PDAs to permit security personnel, such as policemen and security guards to access video surveillance data while on patrol.

In accordance with an important aspect of the invention, portions of the video content corresponding to human faces or other objects of interest are scrambled before transmission in order to preserve privacy rights. The encoded data may be further encrypted prior to transmission over the network for security. In accordance with another important aspect of the invention, the scrambled portions of the video content may be selectively unscrambled to enable persons or objects to be identified.

### Smart Surveillance Camera

A simplified flow chart for a smart surveillance camera in accordance with the present invention is illustrated in FIG. 2. Video content is acquired in step 38 by a capture device, such as a smart surveillance camera 22, 24, 26, which may include a camera and a PC, as discussed below. The camera may be connected to the PC by way of a USB port. The PC may be coupled in a wired or wireless network, such as a WiFi (also known as a Blue Tooth or IEEE 822.11) network.

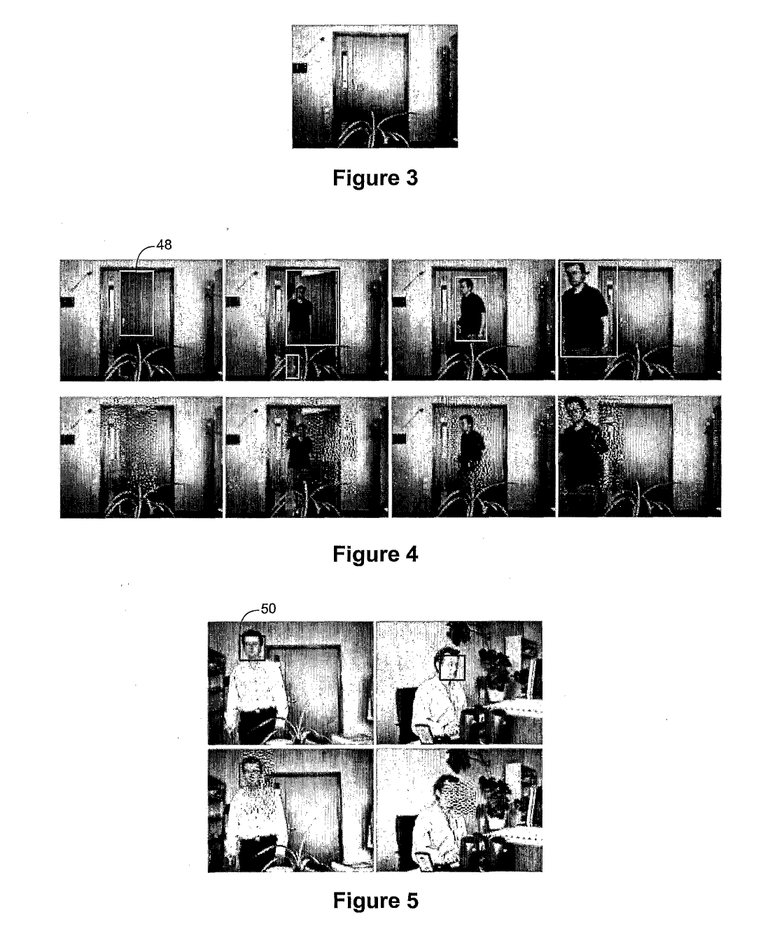

The camera may be a conventional web cam, for example a QuickCam Pro 4000, as manufactured by Logitech. The PC may be a standard laptop PC with a 2.4 GHz Pentium processor. Such conventional web cams come with standard software for capturing and storing video content on a frame by frame basis. All of the video content processing by the smart surveillance cameras 22, 24 and 26, described below in steps 40-46, can be performed by the PC at about 25 frames per second when capturing video data in step 38 and processing video with a resolution of 320×240. As illustrated and discussed below in connection with FIGS. 3-5, video captured with a 320×240 spatial resolution may be encoded with three layers of wavelet decomposition and code-blocks of 16×16 pixels.

Alternatively, the smart surveillance camera can be a camera server which includes a stand-alone video camera with an integrated CPU that is configured to be wired or wirelessly connected to a private or public network, such as, TCP/IP, SMTP E-mail and HTTP Web Browser networks for transmitting live video images. An exemplary camera server is a Hawking Model No. HNC320W/NC300 camera server.

The video content is analyzed in step 40 to detect the occurrence of events in the scene (e.g. intrusion, presence of people). The goal of the analysis is to detect events in the scene and to identify regions of interest. The information about the objects in the scene is then passed on in order to encode the object with better quality or to scramble it, or both. As mentioned above, relying on a human operator monitoring control screens in order to set off an alarm is notoriously inefficient. Therefore, another purpose of the analysis may be to either bring to the attention of the human operator abnormal behaviors or events, or to automatically trigger alarms.

The video may then be encoded using a standard compression technique, such as JPEG 2000, in step 42 as described in more detail below. The encoded data may be further scrambled or encrypted in step 44 in order to prevent snooping, and digitally signing it for source authentication and data integrity verification. In addition, regions of interest can be coded with a superior quality when compared to the rest of the scene. For example, regions of interest can be encoded with higher quality, or scrambled while leaving the remaining data in a scene unaltered. Finally, the codestream is packetized in step 46 in accordance with a transmission protocol, as discussed below, for transmission to the server 27. At this stage, redundancy data can optionally be added to the codestream in order to make it more robust to transmission errors.

Various metadata, for example data about location and time, as well as about the region in the scene where a suspicious event, intrusion or person has been detected, gathered from the scene as a result of the analysis can also be transmitted to server 27. In general, metadata relates to information about a video frame and may include simple textual/numerical information, for example, the location of the camera and date/time, as mentioned above, or may include some more advanced information, such as the bounding box of the region where an event or intrusion has been detected by the video analysis module, or the bounding box where a face has been detected. The metadata may even be derived from the face recognition, and therefore could include the name of the recognized persons (e.g. John Smith has entered the security room at time/date).

Metadata 48 is generated as a result of the video analysis in step 40 and may be represented in XML using MPEG-7, for example, and transmitted in step 50 separately from the video only when a suspicious event is detected. As it usually corresponds to a very low bit rate, it may be transmitted separately from the video, for instance using TCP-IP. Whenever a metadata message is received, it may be used to trigger an alarm on the monitor of the guard on duty in the control room (e.g. ring, blinking, etc . . . ) or be used to generate a text message and sent to a PDA, cell phone, or laptop computer.

Since the above processes are performed in the smart surveillance camera 22, 24 and 26, it is paramount to keep the energy consumption low, while obtaining the highest quality of coded video. As discussed in more detail below, this goal is achieved by an optimization process which aims at finding the best compromise between the following two parameters: power consumption and perceived decoded video. This is as opposed to the conventional approach of optimization based on bit rate versus Peak-Signal-to-Noise-Ratio (PSNR) or Mean Square Error (MSE) as parameters.

Change Detection

Various techniques are known for detecting a change in a video scene. Virtually all such techniques can be used with the present invention. However, in accordance with an important aspect of the invention, the system assumes that all cameras remain static. In other words, the cameras do not move and are continuously in a static position thereby continuously monitoring the same scene. In order to reduce the complexity of the video analysis in step 40, a simple frame difference algorithm may be used. As such, the background is initially captured and stored, for example as illustrated in FIG. 3. Regions corresponding to changes are merely obtained by taking the pixel by pixel difference between the current video frame and the stored background, and by applying a threshold. For example, the change detection may be determined by simply taking the difference between the current frame and a reference background frame and determining if the difference is greater than a threshold. For each pixel x, a difference Dₙ(x)=Iₙ(x)−B(x) is calculated, where Iₙ(x) is the n-th image and B(x) is the stored background.

A change mask M(x) may be generated according to the following decision rule:
M(x)=1 if |Dₙ(x)|>T
0 Otherwise
where T is the threshold and M(x) is the pixel in the image being analyzed.

The threshold may be selected based on the level of illumination of the scene and the automatic gain control and white balance in the camera. The automatic gain control relates to the gain of the sensor while the white balance relates to the definition of white. As the lighting conditions change, the camera may automatically change these settings, which may affect the appearance of the captured images (e.g. they may be lighter or darker), hence adversely affecting the change detection technique. To remedy this, threshold may be adjusted upwardly or downwardly for the desired contrast.

In order to take into account changes of illumination from scene to scene, the background may be periodically updated. For instance, the background can be updated as a linear combination of the current frame and the previously stored background as set forth below
Bₙ=αIₙ+(1−α)βₙ₋₁
if n=iF with i=1,2 (F is the period of the update)
Bₙ=Bₙ₋₁ otherwise
Where Bₙ=the current background
Bₙ₋₁=the previous background
Iₙ=the current frame
α=a constant

FIG. 4 illustrates the change detection technique. In particular, the top row illustrates a bounding box, generally identified with the reference numeral 48, which surrounds a portion of the changed regions of the changing scenes in successive video frames. The bottom row illustrates optional scrambling of changed regions of the video scenes. As will be described in more detail below, scrambling is optionally applied, for example, on the sub bands corresponding to the highest wavelet resolution levels (i.e. resolutions 2 and 3). With such settings, a good localization of the scrambled regions is obtained and the distortion introduced in the image is low enough to enable the scene to be viewed and understood but not sufficient to enable the person or object under surveillance to be recognized.

In order to smooth and to clean up the resulting change detection mask, a morphological filter may be applied. Morphological filters are known in the art and are described in detail in: Salembier et al , “Flat Zones Filtering Connected Operators and Filters by Reconstruction”, IEEE Transactions on Image Processing, Vol. 4, No. 8, August 1995, pages 1153-1160, hereby incorporated by reference. In general, morphological filters can be used to clean-up a segmentation mask by removing small segmented regions and by removing small holes in the segmented regions. Morphological operations modify the pixels in an image depending on the neighboring pixels and Boolean operations by performing logical operations on each pixel.

Two basic morphological operations are dilation and erosion. Most morphological operations are based on these two operations. Dilation is the operation which gradually enlarges the boundaries of regions in other words allows objects to expand, thus potentially filling in small holes and connecting disjoint objects. Erosion operation erodes the boundaries of regions. It allows objects to shrink while the holes within them become larger. The opening operation is the succession of two basic operations, erosion followed by dilation. When applied to a binary image, larger structures remain mostly intact, while small structures like lines or points are eliminated. It eliminates small regions, smaller than the structural element and smoothes regions' boundaries. The closing operation is the succession of two basic operations, dilation followed by erosion. When applied to a binary image, larger structures remain mostly intact, while small gaps between adjacent regions and holes smaller than the structural element are closed, and the regions' boundaries are smoothed.

### Face Detection

The detection of the presence of people in the scene is one of the most relevant bits of information a video surveillance system can convey. Virtually any of the detection systems described above can be used to detect objects, such as cars, people, license plates, etc. The system in accordance with the present invention may use a face detection technique based on a fast and efficient machine learning technique for object detection, for example, available from the Open Computer Vision Library, available at http://www.Sourceforge.net/projects/opencvlibrary, described in detail in Viola et al, “Rapid Object Detection Using a Boosted Cascade of Simple Features, IEEE Proceedings CVPR. Hawaii, December 2001, pages 511-518 and Lienhart et al “Empirical Analysis of Detection Cascades of Boosted Classifiers for Rapid Object Detection”; MRL Technical Reports, Intel Labs, 2002.

The face detection is based on salient face feature extraction and uses a learning algorithm, leading to efficient classifiers. These classifiers are combined in cascade and used to discard background regions, hence reducing the amount of power consumption and computational complexity.

Video Encoding

The captured video sequence may be encoded using standardized video compression techniques, such as JPEG 2000 or other coding schemes, such as scalable video coding offering similar features. The JPEG 2000 standard is well-suited for video surveillance applications for a number of reasons. First, even though it leads to inferior coding performance compared to an inter-frame coding schemes, intra-frame coding allows for easy browsing and random access in the encoded video sequence, requires lower complexity in the encoder, and is more robust to transmission errors in an error-prone network environment. Moreover, the JPEG 2000 standard intra-frame coding outperforms previous intra-frame coding schemes, such as JPEG, and achieves a sufficient quality for a video surveillance system. The JPEG 2000 standard also supports regions of interest coding, which is very useful in surveillance applications. Indeed, in video surveillance, foreground objects can be very important, while the background is nearly irrelevant. As such, the regions detected during video analysis in step 40 (FIG. 2) can be encoded with high quality, while the remainder of the scene can be coded with low quality. For instance, the face of a suspect can be encoded with high quality, hence enabling its identification, even though the video sequence is highly compressed.

Seamless scalability is another very important feature of the JPEG 2000 standard. Since the JPEG-200 compression technique is based on a wavelet transform generating a multi-resolution representation, spatial scalability is immediate. As the video sequence is coded in intra-frame, namely each individual frame is independently coded using the JPEG 2000 standard, temporal scalability is also straightforward. Finally, the JPEG 2000 codestream can be build with several quality layers optimized for various bit rates. In addition, this functionality is obtained with negligible penalty cost in terms of coding efficiency. The resulting codestream then supports efficient quality scalability. This property of seamless and efficient spatial, temporal and quality scalability is essential when clients with different performance and characteristics have to access the video surveillance system.

Techniques for encoding digital video content in various compression formats including JPEG 2000 is extremely well known in the art. An example of such a compression technique is disclosed in: Skodras et al. “The JPEG 2000 Still Image Compression Standard”; IEEE Signal Processing Magazine; volume 18, September 2001, pages 36-58, hereby incorporated by reference. The encoding is performed by the smart surveillance cameras 22, 24 and 26 (FIG. 1) as discussed above. As illustrated in FIG. 2, video encoding is done in step 42.

Security

Secured JPEG 2000 (JPSEC), for example, as disclosed in Dufaux et al. “JPSEC for Secure Imaging in JPEG 2000”; Journal of SPIE Proceedings—Applications of Digital Image Processing XXVII, Denver, Colo., November 2004, pages 319-330, hereby incorporated by reference, may be used to secure the video codestream. The JPSEC standard extends the baseline JPEG 2000 specifications to provide a standardized framework for secure imaging, which enables the use of security tools such as content protection, data integrity check, authentication, and conditional access control.

JPSEC is used in the video surveillance system in accordance with the present invention as a tool for conditional access control. For example , pseudo-random noise can be added to selected parts of the codestream to scramble or obscure persons and objects of interest. Authorized users provided with the pseudo-random sequence can therefore remove this noise. Conversely, unauthorized users will not know how to remove this noise and consequently will only have access to a distorted image. The data to remove the noise may be communicated to authorized users by means of a key or password which describes the parameters of to generate the noise, or to reverse the scrambling and selective encryption applied.

In order to fully exploit and retain the properties of the JPEG 2000 standard, the scrambling may be selectively applied on the code-blocks composing the codestream. The system is composed of three main components: scrambling, pseudo-random number generator and an encryption algorithm. The scrambling can be performed on quantized wavelet coefficients or alternatively directly on the codestream. In the first case, the signs of the coefficients in each code-block are inverted pseudo-randomly, while in the second case, bits of the codestream are flipped. In both cases, the scrambling process is driven by a pseudo-random number generator using several seed values. To communicate the seed values to authorized users, they may be encrypted and inserted in the JPSEC codestream.

An important aspect of the system in accordance with the present invention is that it may use a conditional access control technique to preserve privacy. With such conditional access control, the distortion level introduced in specific parts of the image can be controlled. This allows for access control by resolution, quality or regions of interest in an image. Specifically, it allows for portions of the video content in a frame to be scrambled. In addition, several levels of access can be defined by using different encryption keys. For example, people and/or objects in a scene that are detected may be scrambled without scrambling the background scene. In particular, as discussed in Dufaux et al. “JPSEC for Secure Imaging in JPEG 2000”; scrambling may be selectively applied only to the code-blocks corresponding to the regions of interest. Furthermore, the amount of distortion in the protected image can be controlled by applying the scrambling to some resolution levels or quality layers. In this way, people and/or objects, such as cars, under surveillance cannot be recognized, but the remaining of the scene is clear. The encryption key can be kept under tight control for the protection of the person or persons in the scene but available to selectively enable unscrambling to enable objects and persons to be identified.

Two levels of scrambling can be used with this conditional access control technique: on the one hand the regions of interest may be scrambled and the corresponding seeds encrypted with a first key; on the other hand the whole image may scrambled and the corresponding seeds encrypted with a second key. As such, someone snooping on the system will not have access to the video data. Moreover, operators of the surveillance system, in possession of the second encryption key, will be able to view the scene but not fully recognize people and/or objects present. In such an embodiment, only persons with both encryption keys will be able view the

FIG. 5 illustrates scrambling. In particular, the top row illustrates a bounding box 50 around the detected face. The bottom row illustrates that the face within the bounding boxes 50 has been scrambled, for example, with scrambling applied on the sub-bands of the two highest resolution levels (i.e. resolutions 2 and 3). As shown, the scrambled regions are well localized and the distortion is sufficient such that the person under surveillance in the scene can not be recognized.

A JPSEC tool for data integrity may also be used to detect tampering of the codestream by an attacker, as described in detail in Dufaux et al. “Securing JPEG 2000 Compressed Images”; Journal of SPIE Proceedings—Applications of Digital Image Processing XXVI, San Diego , Calif., November 2003, pages 397-406, hereby incorporated by reference. A particularly efficient way to achieve this is to use a technique based on hashing and digital signatures of the codestream on a code-block basis on JPEG 2000 compressed bit streams.

Despite efficient use of JPSEC in the described system, other alternative techniques for securing and authenticating video can replace the above mentioned security methods in the described system.

Transmission

A significant part of the cost associated with a video surveillance system is in the deployment and wiring of cameras. In addition, it is often desirable to install a surveillance system in a location for a limited time, for instance during a manifestation or a special event. The attractiveness of a wireless network connecting the smart cameras appears therefore very clearly. It enables very easy, flexible and cost effective deployment of cameras wherever wireless network coverage exists.

However, wireless networks are subject to frequent transmission errors. In order to solve this problem, wireless imaging solutions have been developed which are robust to transmission errors. In particular, Wireless JPEG 2000 or JPWL has been developed as an extension of the baseline JPEG 2000 specification, as described in detail in Dufaux et al. “JPWL:JPEG 2000 foe Wireless Applications”; Journal of SPIE Proceedings—Applications of Digital Image Processing XXVII, Denver, Colo., November 2004, pages 309-318, hereby incorporated by reference. It defines additional mechanisms to achieve the efficient transmission of JPEG 2000 content over an error-prone network. It is shown that JPWL tools result in very significant video quality improvement in the presence of errors. In the video surveillance system in accordance with the present invention, JPWL tools may be used in order to make the codestream more robust to transmission errors and to improve the overall quality of the system in presence of error-prone transmission networks.

Obviously, many modifications and variations of the present invention are possible in light of the above teachings. Thus, it is to be understood that, within the scope of the appended claims, the invention may be practiced otherwise than is specifically described above.

What is claimed and desired to be secured by a Letters Patent of the United States is:

We claim:

1. A smart video surveillance system comprising:
at least one smart video surveillance camera configured to capture video content of an area of interest, analyze said captured video content and identify objects of interest, scramble portions of said video content corresponding to said objects of interest, and transmit said video content over a network;
a server coupled to said network for receiving and storing said encoded video content; and
at least one client coupled to said network for accessing said video content stored on said server and configured to selectively unscramble portions of interest.

2. The smart video surveillance system as recited in claim 1, wherein said smart video surveillance camera includes a camera and a personal computer.

3. The smart video surveillance system as recited in claim 1, wherein said smart video surveillance camera includes a stand-alone camera server with an integrated cpu.

4. The smart video surveillance system as recited in claim 1, wherein said smart surveillance camera is configured to identify human faces.

5. The smart video surveillance system as recited in claim 1, wherein said smart surveillance camera is configured to capture and identify objects of interest in said captured video content.

6. The smart video surveillance system as recited in claim 5, wherein said smart surveillance camera is configured to capture video content of a background scene of the area of interest and to identify said objects of interest as a function of the difference between said objects of interest relative to said background scene.

7. The smart video surveillance system as recited in claim 6, wherein said smart video surveillance camera is configured to compensate for lighting changes between scenes.

8. The smart video surveillance system as recited in claim 5, wherein said smart surveillance camera is configured to scramble portions of said video scenes corresponding to objects of interest as a function of a first encryption key.

9. The smart video surveillance system as recited in claim 5 wherein said smart surveillance camera is configured to encode portions of said video scenes according to a standard video compression format defining encoded data.

10. The smart video surveillance system as recited in claim 9, wherein said standard compression format is JPEG-2000.

11. The smart video surveillance system as recited in claim 9, wherein said data is encoded and scrambled according to a standard format as a function of a second encryption key.

12. The smart video surveillance system as recited in claim 11, wherein said standard format is Secure JPEG 2000.

13. The smart video surveillance system as recited in claim 9, wherein said smart surveillance camera is configured to transmit said encoded video content to said server over a wireless network using a standard wireless network protocol.

14. The smart video surveillance system as recited in claim 13, wherein said standard wireless network protocol is Wireless JPEG 2000.
